(19) United States
(12) Patent Application Publication
(10) Pub. No.: US 2015/0142896 A1
(43) Pub. Date: May 21, 2015

(54) HANDLING ELECTRONIC MAIL

(71) Applicant: Recloc Ltd., London (GB)

(72) Inventor: Simon Francis Buchanan, London (GB)

(73) Assignee: Recloc Ltd., London (GB)

(21) Appl. No.: 14/082,496

(22) Filed: Nov. 18, 2013

(51) Int. Cl. H04L 12/58

(52) U.S. Cl. CPC H04L 51/00
USPC 709/206

(57) ABSTRACT

The present invention provides a method of handling electronic mail containing information related to recruitment, the method comprising: storing flag information related to recruitment of personnel; receiving, at a first email address, a first email from a sender having a second email address; parsing the email to determine whether the first email is related to recruitment of personnel, wherein parsing comprises comparing information related to the first email with the stored flag information and determining whether any of the stored flag information is present in the information related to the first email; and executing an action as a result of a positive determination. This results in a reduction in disputes and cost to companies that have retained or contingent recruitment agents.

### BACKGROUND OF THE INVENTION

The present invention relates to handling electronic mail related to recruitment. Embodiments of the present invention may relate to handling electronic mail in a manner that helps to ensure that a company is not overcharged when engaging in recruitment activity, and helps to negatescompanies from unwittingly entering into contractual arrangements with a recruiter without clarifying charges.

The recruitment industry, in general, is poorly regulated. Many companies feel that they are over-charged when they use recruitment agents. Furthermore, companies enter into engagements with recruitment agents without being presented with all the required information, most importantly the relevant charges.

When the Curriculum Vitae (CV) of a candidate to fill a role is received by a company from a recruitment agent, the company receiving the CV by email has the potential to engage in a contract with the recruitment agent if action is taken in response. If an interview is arranged with the candidate to whom the CV belongs, a contract is very likely to be formed with the recruitment agent, because most CVs or other such communications from recruitment agents are likely to contain small print stating that the introduction of the candidate to the company is subject to the recruitment agent's terms and conditions. Ostensibly the recruiter has put the potential client on notice of terms and conditions. These terms and conditions usually set a recruitment fee, which is typically calculated as a percentage of the annual salary of the role that the candidate would fill.

Following the arrangement of an interview in this way, if the candidate is subsequently hired, the recruitment agent will invoice the hiring company on terms defined in its standard terms and conditions. If the recruitment agent's standard fee in its terms and conditions is not wildly outside the market rate then the recruitment agent's terms and conditions are likely to be fully enforceable.

Problems can occur when employees of companies engage with recruitment agents without fully considering the implications of the engagement. For example, a company may have a general policy of desiring to negotiate with recruitment agents, in an effort to obtain a lower recruitment fee (e.g. a lower percentage of the annual salary of the role than is stated in the recruitment agent's terms and conditions) than the fee set in the recruitment agent's terms and conditions. However, an employee acting to arrange an interview with a candidate without giving the matter full consideration can lock the company into the recruitment agent's terms and conditions, missing the opportunity for negotiation.

This can result in litigation and disputes over fees. However, the law will often be on the side of the recruitment agent, because, assuming that their terms and conditions are not wildly outside the market rate then they are likely to fully enforceable.

Therefore there is a requirement for a mechanism for organisations that use recruitment companies to monitor email communication from recruiters, with the aim of preventing inadvertent acceptance of the recruitment agent's terms and conditions.

According to a first aspect of the present invention, there is provided a method of handling electronic mail containing information related to recruitment, the method comprising: storing flag information related to recruitment of personnel; receiving, at a first email address, a first email from a sender having a second email address; parsing the email to determine whether the first email is related to recruitment of personnel, wherein parsing comprises comparing information related to the first email with the stored flag information and determining whether any of the stored flag information is present in the information related to the first email; and executing an action as a result of a positive determination.

This method makes it easier for a company to act on emails related to recruitment. As a result, companies can act on the emails related to recruitment appropriately so that excess costs and disputes are avoided.

Excess costs are incurred when a company unwittingly enters into a contract with a recruitment agent based on the recruitment agent's terms and conditions, which are not in line with the company's terms and conditions. The terms and conditions set the price for introducing a candidate to the company.

In some embodiments, the executed action may be the sending of a second email to a third email address. The third email address may the same as second email address. In this case, the second email may contain recruitment terms and conditions of the organisation to which the first email address belongs, the recruitment terms and conditions superseding any terms and conditions from a recruiter.

Advantageously, this method prevents a recruitment agent's terms and conditions from being ratified when a company in the process of recruiting has its own terms and conditions. The terms and conditions of the company being sent back to the recruitment agent may supersede those of the recruitment agent.

In some embodiments, the third email address may be an internal email address, and may belong to a user in the human resources function. In this case, the second email is a copy of the first email. This is advantageous to firms that wish to maintain a record of interactions with recruitment agents. Furthermore, it ensures that the people who specialize in recruitment are made aware of all of the company's recruitment activities.

In some embodiments, the executed action may be the providing of an alert to a user of the first email address. Advantageously, this makes it clear to an employee that they should not act on an email related to recruitment without permission from the Human Resources department, or reminds the employee to consider the ramifications of responding to the email without first establishing the company's terms and conditions with the recruitment agent.

In some embodiments, the flag information may be contained in at least one of an email header, an email body, or an email attachment. Advantageously, this prevents emails related to recruitment bypassing the method as every part of the email is checked.

In some embodiments, the flag information may identify an email address of a recruiter. This results in a more robust parsing procedure, for example it allows recruitment emails to be identified if the email body is blank and the CV is in a picture format.

In some embodiments, the flag information may comprise one or more keywords, or group of words, relating to recruitment. As emails predominantly contain words, identifying keywords is a robust way of identifying that an email is associated with recruitment.

In some embodiments, the method may further comprise determining whether or not the second email address is an internal email address and not executing the action as a result of a positive determination. This prevents emails unnecessarily being sent to employees of the company, and prevents pointless warning messages being displayed to employees, to the frustration of the employees.

In some embodiments, the method may further comprise determining whether or not the second email address is contained in a white list of email addresses and not executing the action as a result of a positive determination. This prevents emails unnecessarily being sent to the company that sent the email which may cause confusion to the sender, particularly if they are a recruiter and terms and conditions have already been established. Also, it prevents pointless warning messages being displayed to employees to the frustration of the employees.

In some embodiments, the method may further comprise determining whether or not the second email address has sent the same email before and not execute the action as a result of a positive determination. This prevents unnecessary emails being sent to the recruiter, which will frustrate the recruiter and give an unprofessional impression.

According to a second aspect of the present invention, there is provided a computer program product comprising computer readable instructions for carrying out the method as described herein.

According to a third aspect of the present invention, there is provided an apparatus comprising: a memory arranged to store information related to recruitment of personnel; an email client arranged to receive a first email from an external email address; a processor for parsing emails to determine whether the first email is related to recruitment of personnel, wherein parsing comprises comparing information related to the first email with the stored flag information and determining whether any of the stored flag information is present in the information related to the first email; and a controller arranged to execute an action as a result of a positive determination.

In some embodiments, the executed action may be the sending of a second email to a third email address. The third email address may the same as second email address.

In this case, the second email may contain recruitment terms and conditions of the organisation to which the first email address belongs, the recruitment terms and conditions superseding any terms and conditions from a recruiter.

In some embodiments, the third email address may be an internal email address, and may belong to a user in the human resources function. In this case, the second email is a copy of the first email.

In some embodiments, the executed action may be the providing of an alert to a user of the first email address.

In some embodiments, the flag information may be contained in at least one of an email header, an email body, or an email attachment.

In some embodiments, the flag information may identify an email address of a recruiter.

In some embodiments, the flag information may comprise one or more keywords relating to recruitment.

In some embodiments, the apparatus may further comprise an external memory for storing configuration information in an XML file.

In some embodiments, the processor and controller may be embedded in the email client. This prevents a company from having to hold separate licenses for the email client software and software incorporating the processor and controller.

In some embodiments, the processor may further be configured to determine whether or not the second email address is an internal email address and the controller is configured to not execute the action as a result of a positive determination.

In some embodiments, the processor may further be configured to determine whether not the second email address is contained in a white list of email addresses and the controller is configured to not execute the action as a result of a positive determination.

In some embodiments, the processor may further be configured to determine whether or not the second email address has sent the same email before and the controller is configured to not execute the action as a result of a positive determination.

The above and other aspects of the present invention will now be discussed, by way of example only, with reference to the accompanying drawings in which:

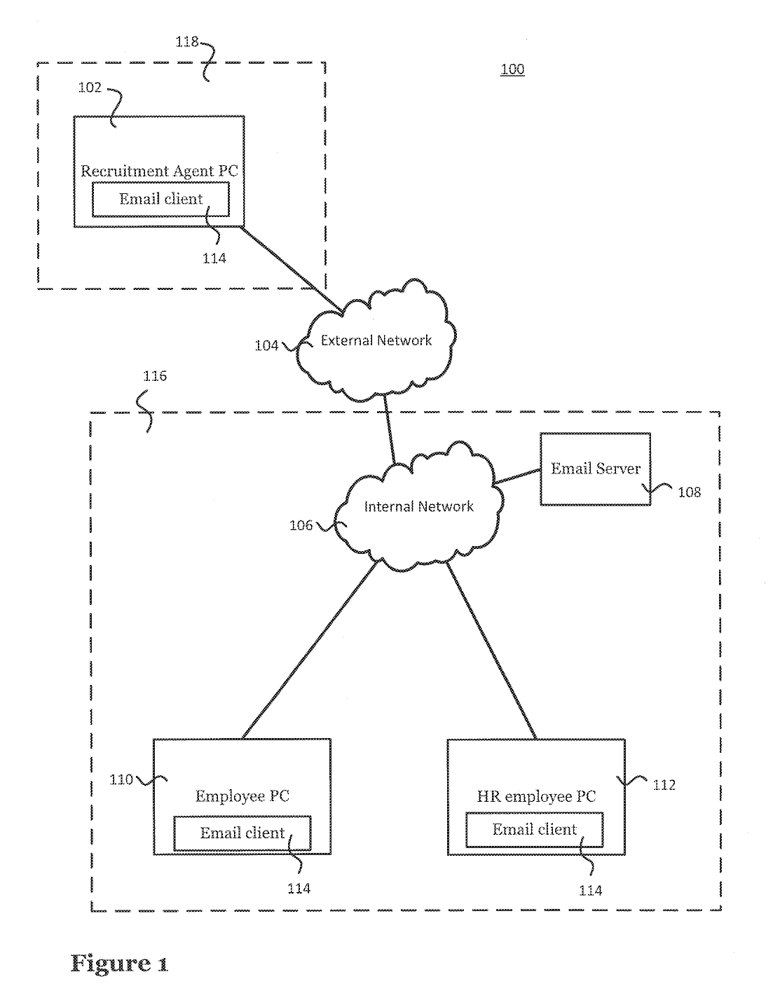

FIG. 1 shows a high level system diagram illustrating an embodiment of the invention;

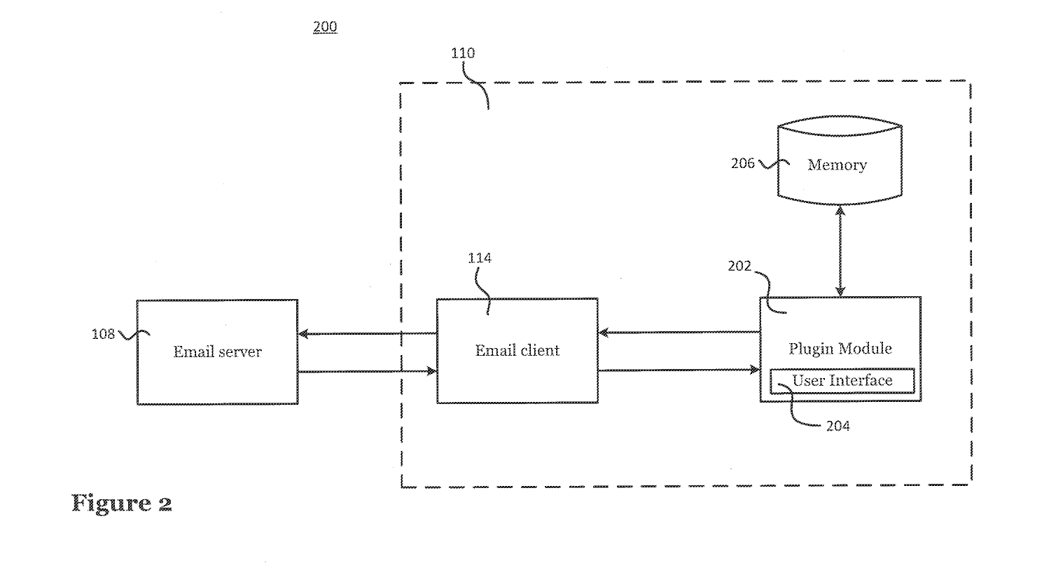

FIG. 2 shows a system diagram illustrating an embodiment of the invention;

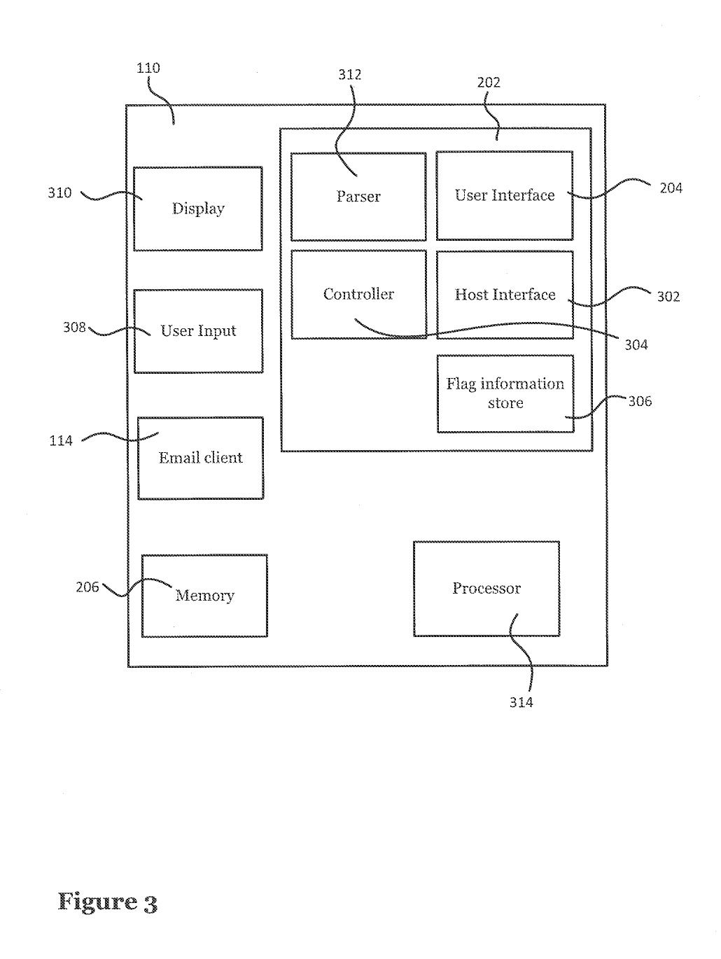

FIG. 3 shows a more detailed system view of a portion of FIG. 2;

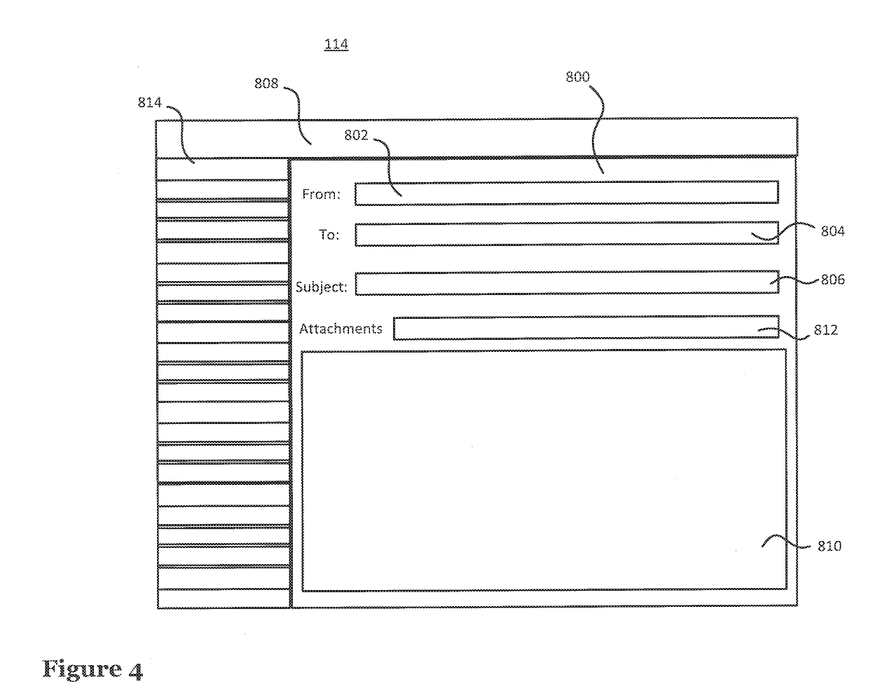

FIG. 4 shows an example of an email client user interface for use in an embodiment of the invention;

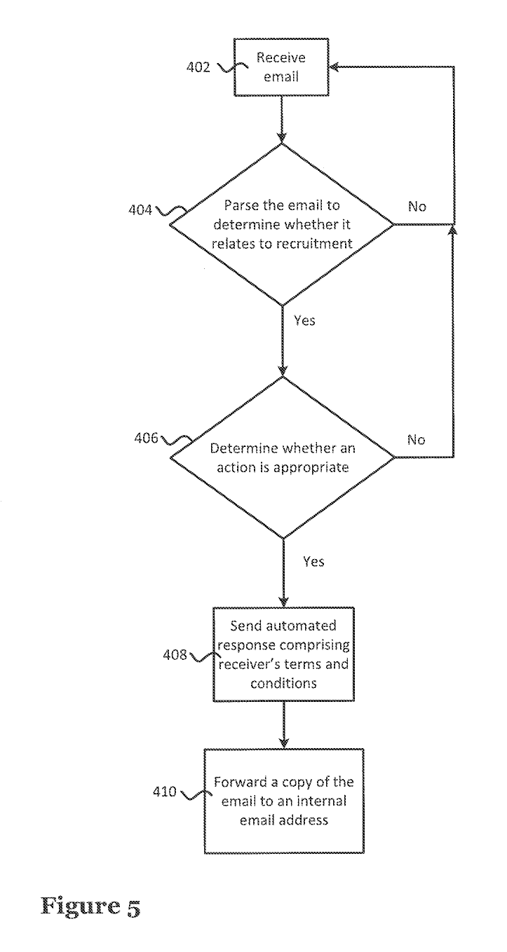

FIG. 5 shows a flowchart describing a method according to an embodiment of the invention;

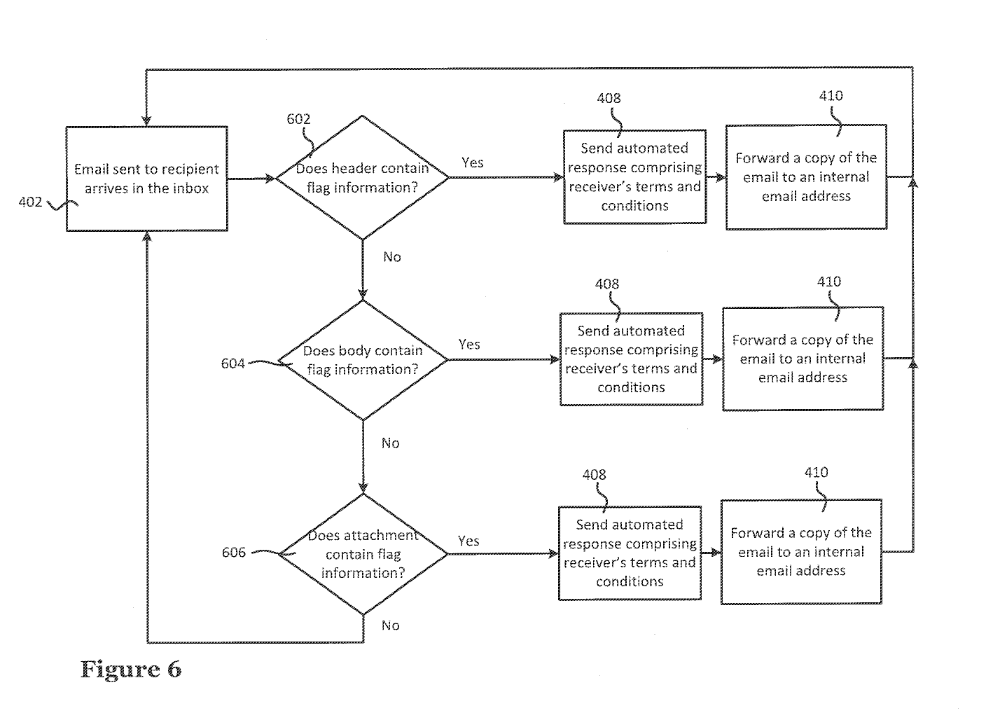

FIG. 6 shows a flowchart describing a parsing procedure according to FIG. 5;

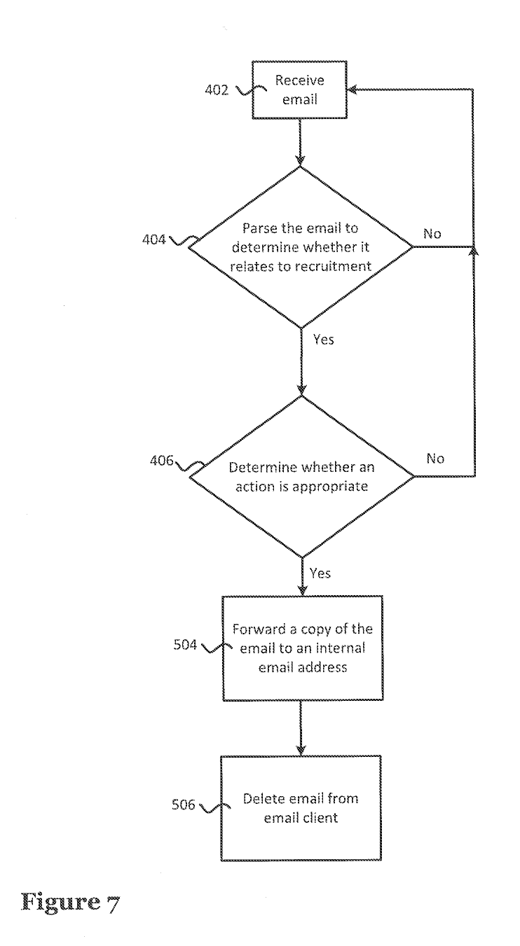

FIG. 7 shows a flowchart describing a method according to an embodiment of the invention;

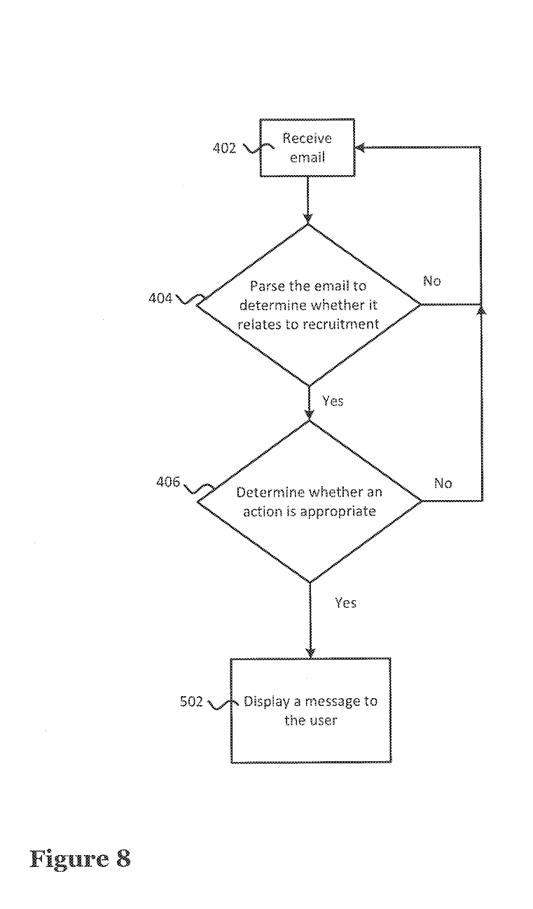

FIG. 8 shows a flowchart describing a method according to an embodiment of the invention; and

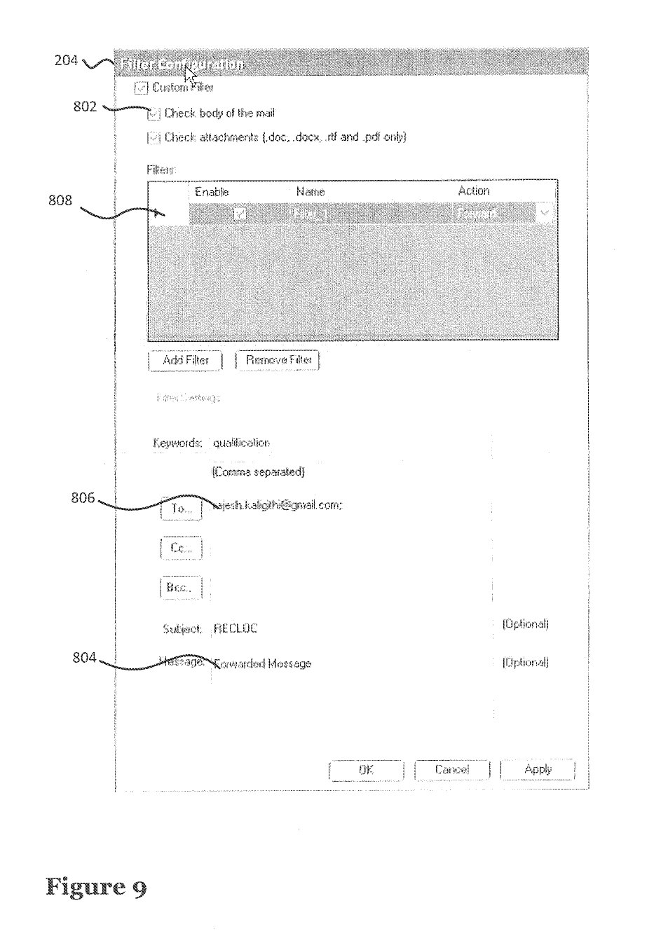

FIG. 9 shows the user interface according to an embodiment of the invention.

Hereinafter handling electronic mail according to embodiments of the invention will be described.

FIG. 1 shows an electronic mail (email) system 100 according to an embodiment of the present invention. A recruitment agent PC 102, having installed therein an email client 114, may belong to a user in a recruitment function, for example at a recruitment agency 118, or the CV stipulates subject to Terms and Conditions without outlining what those terms and conditions are. Nevertheless with or without full terms and conditions the client is ostensibly being put on notice of a contract. The recruitment agent PC 102 may be connected to an external network 104. The external network 104 may be the World Wide Web or another suitable network. The recruitment agent PC 102 is able to send emails via the external network 104. Typically, the recruitment agent PC 102 sends emails to organisations 116 either speculatively or in answer to a recruitment query. Such emails usually contain terms and conditions of the recruitment agent 118, such as an indication of fees which, in the absence of any agreement to the contrary, the external organisation 116 would be bound to if the recruitment agent were engaged.

The organisation 116 has an internal network 106 to which a number of devices are connected. The internal network 106 may be a Local Area Network (LAN). The internal network 106 includes an email server 108. The email server 108 acts as an interface between the internal network 106 and the external network 104. The email server 108 can receive email messages from the recruitment agent PC 102.

In an exemplary embodiment, the server 108 is a Microsoft Exchange Server. The server 108 may be configured to have emails pushed to it. Alternatively, the server 108 may be configured to fetch emails. The server 108 may manage the email accounts of all employees working for the organisation 116. It will be appreciated that each email account has associated therewith an email address.

In this embodiment, employee PCs 110, 112 are shown as being connected to the internal network 106. Employee PC 110 and HR employee PC 112 are shown, though it will be appreciated that the organisation 116 may have many employees, each with their own PC. It will also be appreciated that in some circumstances more than one employee may share an employee PC.

In this embodiment, the user of the HR employee PC 112 is an employee that has a human resources (HR) function within the organisation 116. In other words, the user of the HR employee PC 112 is an HR employee that has responsibilities that may include overseeing the recruitment of candidates to fill roles within the organisation 116. The HR employee may, for example, be a HR manager or other HR employee.

In this embodiment, each employee PC 110, 112 has an email client 114. In an exemplary embodiment, the email client 114 is a version of Microsoft Outlook. In this embodiment, each email client 114 is configured to receive emails from the server 108.

It would be understood to the person skilled in the art that the network architecture could be constructed in a different way to that described above. For example, the server 108 may be coupled to the external network 104 and be operated by a third organisation. In such embodiments, the employee PCs 110, 112 may connect to the server 108 via the external network 104. For example, Google's Googlemail server may be used.

FIG. 2 shows an electronic mail handling system 200 according to an embodiment of the present invention. For example, the system 200 could be implemented in the organisation 116 shown in FIG. 1.

The system 200 comprises an email server 108, which could be of the same type as that described with reference to FIG. 1. The system 200 also includes an employee PC 110 which could be of the same type as that described with reference to FIG. 1.

The employee PC 110 will now be explained in more detail with reference to FIG. 2.

The email client 114 may send and receive emails, via the email server 108. The emails may be sent to or received from email addresses associated with the internal network 106, which will be referred to as internal email addresses. Alternatively the emails may be sent to, or received from, email addresses not associated with the internal network 106, which will be referred to as external email addresses. In an exemplary embodiment, the email client 114 is a version of Microsoft Outlook. A user's email account is associated with the email client 114.

In one embodiment, the employee PC 110 has installed a plugin module 202. As described below, the plugin module 202 stores at least one item of flag information related to recruitment of personnel. The plugin module 202 compares information related to received emails with the item(s) of stored flag information and determining whether the information related to the received emails contains any of the item(s) of stored flag information.

In this embodiment, the plugin module 202 is configured to control the employee PC no to execute an action as a result of the determination.

In this embodiment, the plugin module 202 is implemented as software, and is separate software to the email client 114. The plugin module 202 is configured to parse emails received by the client 114, and perform a comparison. In an exemplary embodiment the software is written in C# language. In other embodiments, the software may be written in another language.

The use of a plugin module 202 in this way enables such embodiments of the invention to be used in conjunction with the existing email systems of an organisation. In other words, by using the plugin module 202 in this way, such embodiments of the invention can be, for example, retrofitted into the existing email systems of an organisation.

In other embodiments, the functionality of the plugin module 202 may be implemented within the software of the email client 114. In other words, the functionality of the plugin module 202 may be implemented as an integral part of the email client 114, rather than as a plugin.

The plugin module 202 may be customised using a user interface 204. An example user interface 204 will be described later with reference to FIG. 8.

A memory 206 is coupled to the plugin module 202. The memory 206 stores settings governing the operation of the plugin module 202. In an exemplary embodiment the settings are contained in a flat XML file. The memory 206 may be installed on the same PC as the email client 114, e.g. the employer PC no, or may be installed on the server 108 or other suitable hardware. In another embodiment, the settings of the plugin module 202 can be embedded in the code of the plugin module 202 itself.

In the plugin module 202. Net Frameworks serialisation and de-serialisation techniques may be used to convert plain C# objects to XML and vice versa. In other embodiments, other frameworks may be used as appropriate.

In another embodiment, the plugin module 202 is integrated with the email server 108. In such embodiments, the employee PC 110 does not have the plugin module 202 installed on it as a separate component, as the functionality of the plugin module 202 may be implemented by an integral part of the email client 114. In other embodiments, the plugin module 202 could be implemented on another hardware module, either connected to the internal network 106 or the external network 104.

FIG. 3 shows a more detailed diagram of an example PC 110 on which the plugin module 202 is implemented according to an exemplary embodiment of the invention. The PC 110 comprises a display 310, a user input 308, a processor 314, the email client 114, the memory 206 and the plugin module 202.

The display 310 is capable of presenting a user with a graphical user interface (GUI).

The user input 308 may take any well-known form. For example, the user input may be a touch screen, or a mouse, or a keyboard.

The processor 314 coordinates the functions of the components of the PC no.

In this embodiment, the memory 206 stores the settings for controlling the plugin module 202.

The plugin module 202 includes a host interface 302, a parser 312, a controller 304, a user interface, and a flag information store 306.

In this embodiment, the host interface 302 is configured to receive emails from the email client 114.

The controller 304 is configured to transmit control information to one or more components of the PC no. As a result, following a positive determination by the plugin module 202, an action can be performed by one or more components of the PC no, as discussed in more detail below.

In one embodiment, the control information causes the email client 114 or other part of the PC 110 to execute an action as a result of the received email.

The action may be for the email client 114 to carry out one of reply, forward, delete, or highlight. For example, if a highlight action is executed, the email descriptor in the email client's 114 inbox may be made to change colour or be displayed in a different font to indicate that the email is related to the recruitment of personnel. The icon identifying the email in the inbox may be changed to an icon not typically associated with emails.

In another embodiment, the control information causes the display 310 to execute an action. For example, the controller 304 controls the processor 312 to generate and display a warning message to the user on the display 310.

The plugin module 202 further includes items of flag information stored in the internal memory. As discussed, the items of flag information are used by the plugin module 202 to determine if an incoming email is related to recruitment.

The items of flag information may be entered by an employee using the user interface 204, for example by someone else at the organisation 116 or preconfigured on the plugin 202 at installation.

The flag information may relate to the recruitment of personnel, and may include at least one item of information. The items of flag information may comprise, for example, known email domains, email addresses and/or names of recruitment agents. The items of flag information may also comprise keywords associated with the recruitment of personnel or other information that could be used to identify that incoming email is related to recruitment.

It will be appreciated that keywords may be contained in the body of the email. Alternatively, or in addition, the keywords may be contained in the header or subject line of the email. Alternatively or in addition again, the keywords may be contained in the email attachment. A keyword could be a word that may appear in a recruitment-related email

For example, a suitable keyword might be “qualification”. A CV typically lists a candidate's qualifications, under the heading “Qualifications”, and so an email containing the CV could be recognised as being related to recruitment by the “qualification” keyword found in the email.

The parser 314 is configured to parse received email. Parsing may involve checking the email address of the sender, the email body, header, or attachment (if the email has an attachment) to see if any of them contain any of the items of flag information. Parsing also involves checking the sender's email address against a list of email addresses that form part of the flag information. The parser 312 may be configured by a user by using the user interface 204.

In another embodiment, the plugin module 202 is installed on the email server 108. In such embodiments, the plugin module 202 is configurable by a network administrator using a suitable user interface. In such embodiments, emails are parsed before they reach the employee PC 110 to prevent the employee acting on them without permission.

In some embodiments, the configuration of the parser 312 may involve setting flag settings, which may be stored in the flag information store 206. The flag settings may comprise settings associated with the items of flag information related to recruitment of personnel.

For example, using a keyword as an example of an item of flag information, a flag setting may be set to cause a positive determination that the email is related to recruitment if the keyword “recruitment” is present in any part of the email, i.e. in any of the header, email body, or attachment.

Alternatively, a flag setting may be set to cause a positive determination that the email is related to recruitment if the keyword “recruitment” is present in all of the header, email body, and attachment.

Furthermore, a flag setting may be set to cause a positive determination that the email is related to recruitment if the keyword “recruitment” is present in the “header OR the email body” AND “the attachment”. In other words, if the keyword “recruitment” is present in a combination of the attachment and at least one of the header and the email body.

Other embodiments can use other combinations of AND or OR logic to determine where in the email the keyword “recruitment” is included so as to cause a positive determination that the email is related to recruitment. Moreover the AND or OR logic could be applied to groupings of words. For example, a set of keywords could be provided, and the flag setting may be set to cause a positive determination that the email is related to recruitment if a certain number of these keywords are found.

Embodiments that use flag settings in this way can do so on a keyword level, so that different keywords can have different flag settings. This is useful in some embodiments because different keywords can have different importance in the determination that the email is related to recruitment.

For example, the keyword “CV” may be more likely to indicate that the email is related to recruitment than the keyword “qualification”. Hence, as an example, the flag setting for the keyword “CV” may be set so that if the keyword is present in any portion of the email, then the parser 312 will determine that the email is related to recruitment. In such an example, the flag setting for the keyword “qualification” may be set so that the parser 312 will determine that the email is related to recruitment only if the keyword is present in the “header OR the email body” AND “the attachment” of the email. By doing this the criteria for a positive determination can be stricter for certain keywords when compared to others.

In addition, embodiments that use flag settings in this way can do so in a way that requires items of flag information to be present in combination.

For example, a flag setting may be set to cause a positive determination that the email is related to recruitment if the keyword “recruitment” is present in any part of the email AND the email is from an email domain or email addresses of a known recruitment agent. In other embodiments, any combination of AND or OR logic with keywords coupled with the email being from an email domain or email addresses of a known recruitment agent could lead to a positive determination.

As another example, a flag setting may be set to cause a positive determination that the email is related to recruitment if the keyword “recruitment” and the keyword “qualification” are present in any part of the email. Other embodiments may require a combination of keywords to be present in the same part of the email so as to determine a positive determination.

As a result of the above, the items of flag information, along with the flag settings enable the parser 312 to be configured to determine with a degree of accuracy whether the email is related to recruitment.

In addition, as described in more detail below, in some cases even if there has been a positive determination that the email is related to recruitment, it still might be preferable to not take an action. For example, an employee of the organisation 116 may have a wife who works for a known recruiter. The organisation 116 may therefore add the wife's email address to a white list of “safe” addresses, as it could be assumed that the wife is most likely to be emailing her husband for personal rather than professional reasons.

As a result, the flag settings can also store exceptions, so that received emails fall within the exceptions stored in the flag settings, no action need be taken.

FIG. 4 shows an example of an email client 114 user interface. In this example, the email client 114 has an inbox 814, where a list of received emails is displayed. Each email in the inbox 814 has a descriptor. The descriptor may be the sender's name, or the subject of the email. Alternatively, the descriptor may include both the sender's name and the subject. The email descriptor may also include an icon indicating whether the email has been read or not. The email client 114 has a toolbar 808, from where a user may configure or control the email client 114. The main window displays an email 800, which may be related to the recruitment of personnel.

An email 800 typically consists of a header 806, also known as a subject line, a “from” field 802, a “to” field 804, and a main body 810. The email 800 may further comprise an attachment 812. Typically, emails received from recruitment agents have CVs or other recruitment information attached. Attachments 812 may be in any format readable by the PC no. For example, an attachment may be in PDF format or other such formats. In some embodiments, the attachment may be in a compressed format such as any one of zip, cab and rar.

The “from” field 802 includes the email address or name of the individual or company sending the email. An email address includes an ampersand followed by a domain name, for example, “@recloc.com”. The “to” field 804 includes the name or email address of the individual or company receiving the email.

FIG. 5 shows an example flowchart for the operation of the email client plugin module 202 according to an embodiment of the present invention.

Prior to operation of the plugin module 202, an email is received by an employee's email address at the email client 114. The email may contain an attachment, such as a Curriculum Vitae (CV). The email may have been pushed to the email client 114 by the server 108. Alternatively, the email client 114 may have fetched the email from the server 108.

The plugin module 202 then operates on the received email. At the time of the plugin module 202 operation, the flag information and any flag settings stored in the memory 206 in XML string format are de-serialised into C# objects.

In this example, the flag information and any flag settings will have been previously entered by a user using the user interface 204, or preconfigured on installation of the plugin module 202.

In a first step 402, an email is received at the plugin module 202 through the host interface 302.

In step 404, the parser 312 parses information related to the email to determine whether it is related to recruitment. More specifically, in this example, the parser 312 determines whether information related to the received email contains at least one item of flag information indicating that the email is related to recruitment. In an example, the items of flag information comprise keywords and a list of email domains of known recruiters.

The flag information is configured by a user using the user interface 204. After being set by the user, C# objects are serialised into an XML string and stored in the memory 206.

If, as a result of step 404, the parser 312 determines that there is no item of flag information present in the information related to the received email, no action is performed by the PC 110 as a result of receiving the email. The parser 312 then scans the next email received by the host interface 302.

If the received email is determined to be related to recruitment, i.e. the parser 312 identifies at least one item of flag present in the information related to the received email, the plugin module 202 executes step 406.

In step 406, the parser 312 determines whether an action should be performed by the PC 110 as a result of receiving the recruitment-related email. This can be done by checking the flag settings to see if the received email falls within any exceptions stored in the flag settings.

For example, in some embodiments, an exception in the flag settings could relate to internal email addresses. In such cases, the parser 312 may check whether the email has been received from an internal email address, which may be determined from its domain. Alternatively, an internal email address may be determined by checking a list of email addresses stored in memory 206. In this embodiment, if the email is sent from an internal email address, no action is performed by the PC 110 as a result of receiving the recruitment-related email. The parser 312 then scans the next email received by the host interface 302. This can prevent needless actions being taken when, for example, a colleague of the user of the PC 110 sends a messages that happens to contain, for example, a recruitment related keyword.

Furthermore, an exception in the flag settings could relate to email addresses in a stored white list. In such cases, the parser 312 may check whether the email has been received from an email address stored in a white list. The white list may be a list of email addresses for which no action is necessary, for example, an email address of a friend of the user of the PC 110 that the user knows is not a recruitment agent. The white list may stored in memory 206. If the email is sent from an email address on the white list, no action need be performed by the PC 110 as a result of receiving the recruitment-related email. The parser 312 then scans the next email received by the host interface 302. Such a white list can prevent needless actions being taken when, for example, a friend of the user of the PC 110 sends a message that happens to contain, for example, a recruitment related keyword.

In some embodiments, an exception in the flag settings could relate to emails that are not the first emails in a same email chain. In such cases, the parser 312 may determine whether a received email comprises a same email header 806 as a previous email received from the same sender. In such embodiments, if the received email comprises the same email header 806 as the previous email received from the second email address, then no action need be performed by the PC 110 as a result of receiving the recruitment-related email. The parser 312 then scans the next email received by the host interface 302. This can prevent needless actions being taken when, for example, a string of messages are received from (and then replied to) a recruiter. In some embodiments, it is only necessary to take the action in respect of the first message from the recruiter, rather that in response to every message in an email chain.

It will, of course, be appreciated the parser 312 may determine whether a received email comprises a same email header 806 by comparing the email header of the received email to the header of previous emails. In doing this, the parser may ignore standard header conventions such as “RE:”, “FW:” that may be appended to the start of an email header 806 once a message chain develops. Furthermore, some email clients append a reference stem (e.g. for a document management system) to the end of the email header 806. The parser 312 may ignore such additions to the email header to determine that received email comprises a same email header 806 as a previous email. The parser may use any standard way of identifying whether a received email is part of a same email chain.

If, as a result of step 406, the parser 312 determines that an action needs to be performed by the PC no, the plugin module 202 executes step 408. In step 408, the plugin module 202 controls the email client 114 to perform an action on the received email.

In this embodiment, the action is to send an automatic reply to the sender's email address, which in this embodiment is a standardised email message that contains the recruitment terms and conditions of the organisation to whom the email client 114 belongs.

In this embodiment, at step 410 the plugin module 202 controls the email client 114 to forward a copy of the received email to an internal email address, such as that of the organisation's managing director or human resources manager.

An example of the operation of step 404 is shown in more detail as steps 602, 604, and 606 in FIG. 6, using the example in which the items of flag information comprise keywords (e.g. “qualification”, “candidate”, “salary”, “CV” etc) that may be likely to relate to recruitment.

Also, this example will be explained in the context of a received email that comprises a header (e.g. a subject line) 806, an email body (e.g. where message text is written) 810 and an attachment 812. It will be appreciated that embodiments of the invention are applicable to a number of email types, e.g. plain, rich and html text etc. In addition, it will be appreciated that the attachment 812 may be in a number of different formats. For example, the attachment 812 may be in PDF format or other suitable formats such as a compressed format such as any one of zip, cab and rar.

In step 602, the parser 312 determines if the header of the email contains any of the items flag information. In other words, in this example, the parser 312 determines if the header contains any of the keywords.

If the header of the email contains any of the items flag information, then in this example, at step 408 the email client 114 sends an automated response comprising receiver's terms and conditions to the sender of the email. At step 410, a copy of the received email is sent to an internal email address, e.g. a member of the HR function of the organisation to which the recipient of the received email belongs.

If the header 806 of the email does not contain any of the items flag information, then the process moves to step 604.

In step 604, the parser 312 determines if the body of the email 810 contains any of the items flag information. In other words, in this example, the parser 312 determines if the body of the email 810 contains any of the keywords.

If the body of the email 810 contains any of the items flag information, then, in this example, at step 408 the email client 114 sends an automated response comprising receiver's terms and conditions to the sender of the email. At step 410, a copy of the received email is sent to an internal email address, e.g. a member of the HR function of the organisation to which the recipient of the received email belongs.

If the body of the email 810 does not contain any of the items flag information, then the process moves to step 606.

In step 606, the parser 312 determines if the email attachment 812 contains any of the items flag information. In other words, in this example, the parser 312 determines if the email attachment 812 contains any of the keywords. In some embodiments, the system can handle a number of text bases—including and not limited to pdf, txt, rtf, word and google text based file extensions.

It will be appreciated that the parser 312 of some embodiments of the invention can parse a number of different file formats. For example, if the attachment 812 is in a compressed format such as any one of zip, cab and rar, the parser 312 of some embodiments of the invention can parse these formats in a suitable way.

If the email attachment 812 contains any of the items flag information, then in this example, at step 408 the email client 114 sends an automated response comprising receiver's terms and conditions to the sender of the email. At step 410, a copy of the received email is sent to an internal email address, e.g. a member of the HR function of the organisation to which the recipient of the received email belongs.

If the email attachment 812 does not contain any of the items flag information, then the process moves back to step 402 and waits for the next received email.

As a result, in this embodiment, the parser 312 compares the header, body of the email, and attachment in turn to see if they contain any of the items flag information. Hence, in this embodiment, the parser 312 is set to determine that the email is related to recruitment if any of the header, body of the email, and attachment contain any of the items flag information.

As discussed, in other embodiments, the parser 312 could be set to determine that the email is related to recruitment only if a combination of the header, body of the email, and attachment contain any of the items flag information. For example, the parser 312 may be set to determine that the email is related to recruitment only if the “header AND the body of the email” OR the “attachment” contain any of the items flag information.

As another example, the parser 312 may be set to determine that the email is related to recruitment only if the “header AND the attachment” or the body of the email contain any of the items flag information.

In other embodiments, the parser 312 may be set to determine that the email is related to recruitment based on any combination of AND, OR logic based on the header, body of the email, and attachment.

Also, as discussed, the parser 312 may be set to determine that the email is related to recruitment based on keywords in addition or as an alternative to other types items of flag information, such as email address of the sender.

A practical example of how the handling system 200 may be used in this embodiment will now be discussed.

In this example, a large bank “XYZ” 116, has 10,000 employees, and as a result regularly needs to use recruitment consultants. In this example, bank XYZ uses contingent recruitment agents 118 to filter candidates, due to the large number of applicants, and the recruitment agents supply regularly employees of bank XYZ with appropriate CVs.

The HR department of bank XYZ has detailed policies for the way recruitment should be handled so as to reduce the costs involved in recruitment. In particular, the HR department of bank XYZ has developed a set of recruitment terms and conditions that it wishes to use instead of the standard terms and conditions of the recruiters. This enables the HR department of bank XYZ to know, on the assumption that their terms and conditions supersede the standard terms and conditions of the recruiters, what the cost of recruitment will be in advance.

It will be appreciated that there may be situations in which XYZ's terms and conditions supersede those of the recruiter, Essentially where a contract has been formulated and agreed by both parties. This is typical on preferred suppliers lists that companies set up with preferred suppliers. This relates to retained and contingent business. Nevertheless the automated response puts the recruiters on notice of client terms and invites them to agree terms, with the client being in a stronger position because they have been approached and under no obligation to do business with a new recruitment firm. The likelihood is that a recruiter will believe that a new business relationship is valuable and will accept the rate.

This also enables bank XYZ to use its purchasing power to ensure that it gets the best deal possible. For example, bank XYZ's recruitment terms and conditions may specify a lower recruitment fee than specified in the standard terms and conditions of the recruiters.

Unexpected costs can be incurred when an employee of bank XYZ uses a CV provided by a recruitment agent to arrange an interview with a candidate, without first trying to impose bank XYZ's recruitment terms and conditions. For example, bank XYZ's recruitment terms and conditions may specify a recruitment fee of 15% of the annual salary of a new employee, whereas the standard terms and conditions of the recruiter may specify a recruitment fee of 25% of the annual salary of a newly placed employee.

It will be appreciated that a CV from a recruitment agent typically contains small print explaining or alluding to the terms and conditions of the recruitment agent, —this essentially puts the client on notice that bank XYZ may be obliged to uphold if an interview is arranged. Hence, arranging an interview without the consent of the HR department (who would seek to impose bank XYZ's recruitment terms and conditions) could lead to an employee of bank XYZ costing bank XYZ a considerable amount in recruitment fees.

In this example, bank XYZ is a large organisation with department heads that hire people on their own accord, and conventionally in such conditions it would be difficult for all the employees of bank XYX to adhere to bank XYZ's HR policies. As such, conventionally, it would be difficult for the HR department of bank XYZ to be in complete control of recruitment.

To overcome these issues, and to provide bank XYZ with a way of helping ensure that its recruitment policies are properly implemented to reduce the overhead associated with recruitment, bank XYZ uses an apparatus for handing emails according to an embodiment of the present invention, for example, as described herein with reference to FIGS. 1 to 6.

In this example, the plugin module 202 is installed in the PC 110 of every department head by an IT administrator using Group Policy, as a plugin to the existing email clients 114 used on each PC.

Consider a scenario in which bank XYZ in is looking to hire a new trader for the Asian market. A recruitment agent, BankRec 118 then sends an email to the PC 110 of the head of the Asian markets division with attached CVs of candidates for the role of trader. The CVs in this example have included therein implied terms and conditions of BankRec. In this example, BankRec charges a fee of 25% of the annual salary for placing a successful candidate as well as a percentage of first year earnings and/or bonus, relocation costs and car allowance

As will be appreciated from the above, if bank XYZ uses the information provided by BankRec to arrange an interview with a candidate trader, without imposing bank XYZ's recruitment terms and conditions, then bank XYZ may be obliged to pay BankRec's fee at the rate specified in BankRec's recruitment terms and conditions, as opposed to the lower rate specified in bank XYZ's recruitment terms and conditions.

However, to avoid this occurring, the plugin module 202 automatically identifies emails received from BankRec as being related to recruitment, using for example the process discussed above in relation to FIG. 6.

In this example, the flag information store 306 comprises items of flag information that comprise a list of domain names. In this example, BankRec's domain, @bankrec.com, is one of those listed. Furthermore, the items of flag information comprise a list of keywords which identify emails as related to recruitment. In this example, the list of keywords comprise: “qualification”, “recruitment”, “CV”, “curriculum vitae”. It will be appreciated that in some practical implementations, the list of keywords could comprise a different set of keywords.

Furthermore, in this embodiment flag settings are set such that the parser will identify a received email as being related to recruitment if any of the keywords are present in any part of the email, or if the email from one of the domain names in the list of domain names.

In this example, the parser 312 of the plugin module 202 installed on the head of Asian market's PC 110 parses the email to determine whether it is related to recruitment. In this example, it will be assumed that the email from the recruiter BankRec contains the word “qualification” in an attachment, or a combination of the following words:—“qualification”, “education” “CV”, “profile” “career history” and “employment”.

In this example, on receiving an email from BankRec relating to the trader, the plugin 202 installed on the head of Asian market's PC 110 parses the email by checking the sender's email address against a list stored in the flag information store 306, and checking the email body, header, and attachment for the keywords stored in the flag information store 306.

In this case, the parser 312 determines that the email received from BankRec is related to recruitment based on the item of flag information specifying BankRec's domain and the keyword “qualification” and/or or a combination of the following words:—“qualification”, “education” “CV”, “profile” “career history” and “employment” in the attachment.

As a result of this, the controller 304 controls the email client 114 to send an automated reply to the sender of the email from BankRec. The reply email is a template containing the terms and conditions of bank XYZ.

Bank XYZ has the intention that these automatically sent terms and conditions will supersede BankRec's terms and conditions and specify the 15% fee requested by bank XYZ. As a result, bank XYZ has now attempted to impose its own terms and conditions on BankRec, rather than agreeing (by default) BankRec's terms. This has been done automatically, with no involvement from the HR department of bank XYZ.

It will be noted that if BankRec do not accept bank XYZ's terms and conditions, then a negotiation will take place but the Bank is the stronger position because they have been approached and the recruiter is trying to develop a new client.

In this example, the controller 304 also commands the email client 114 to forward the received email to an employee of bank XYZ in the HR department. This is so the HR department is made aware of all recruitment activity taking place in the bank.

As a result of installing the plugin 202, XYZ does not incur any unexpected recruitment costs as its own terms and conditions can be sent to and imposed upon recruiters without any direct action by either the recipient of the recruitment related email or by the HR department of bank XYZ.

It will be appreciated that a large organisation, such as bank XYZ, would receive a lot of applications from recruitment agents, and so having such an automated system for ensuring that bank XYZ's terms and conditions are sent to all recruiters in response to recruitment emails has the potential to save bank XYZ a great deal of money.

As an example, it is accepted that large organisations/multinationals usually have a preferred supply list with agreed rates however cracks still appear as senior staff have a tendency to engage with recruiters unwittingly believing that HR will sort out the fees at a later date. This is particularly relevant when a recruiter engages that is not on the preferred supply list. There is the added attraction that the methodology according to embodiments of the invention could also reduce costs in relation to preferred supply list suppliers by reducing the rates as stipulated once the plugin has been installed.

An example of reduction in costs for a large company might be as follows:—

Annual recruitment spend—£2,000,000

Retained Recruitment—£600,000

Contingent recruitment—£1,4000,000

Of the contingent recruitment, rates might typically vary between 25%-£35%. If the contingent rate is made uniformed and brought to 20% (by having a better control of recruitment process and enforcing the company's own terms and conditions) then there is a 30% overall reduction in costs. In theory this would bring down the contingent spend down by £1,400,000×30%=£520,000

FIG. 7 shows a flowchart for the operation of the email client plugin module 202 according to another embodiment of the present invention. Steps 402, 404, 406, 602, 604 and 606 may be carried out as in the first embodiment described with reference to FIG. 5 and FIG. 6.

In step 504, as a result of a positive determination that the email is related to the recruitment of personnel, the email client 114 is configured to forward a copy of the received email to an email address on the internal network 106. The email client 114 is controlled to execute the action by the controller 304. Preferably, this email address is of someone fulfilling a human resources (HR) function.

In this embodiment, in step 506, the email client 114 may be configured to delete the email received from the recruitment agent. The email is deleted so that the user can not act on the email and therefore unintentionally agree to the recruitment agent's terms and conditions. In other embodiments, step 506 is not performed and the email remains in the user's inbox 814.

This process is particularly advantageous to organisations that have dedicated Human Resources personnel and a standard policy regarding resourcing terms and conditions in which non-HR employees are specifically prevented from engaging in recruitment activity. All non-HR employees are expected to completely hand over responsibility for recruitment to the human resources department.

An example of how the handling system 200 may be used in this embodiment is as follows. A medium sized accountancy firm Y&E 116, having 50 employees, uses the services of one or more contingent recruitment agents 118.

Y&E needs to hire a new accountant, but conventionally it would face the same problem of unexpected costs associated with recruitment as discussed above. A recruitment agent, AccRec, 118 sends emails to the PC 110 of a senior accountant in the firm 116 each with an attached CV of a potential employee. The emails have included therein implied terms and conditions. The terms and conditions include the recruitment agent's fee information.

To avoid problems with recruiters, Y&E installs an email client 114 with the functionality of the plugin module 202 mentioned above integrated with it. Therefore, the email client 114 has the functionality of the plugin module 202 previously described.

Y&E installs the email client 114 in PC 110 of all employees or installs the plug in on all hiring level employees (e.g. Directors/Ads, Managers), and then advertises the new accountant position on its website and informs its contingent recruitment agents 118.

An email is received at the email client 114 of a senior accountant. The parser 312 of the plugin module 202 parses the received email to determine whether or not it is related to recruitment.

In this example, the parser 312 is configured by a network administrator to check only the header 806 of the email for the keyword “candidate”. The word “candidate” is stored as an item of flag information store 306. In other examples, further flag information could have been used to identify emails as relating to recruitment, for example the sender's name, email address, name of the sending company, or the domain name of the recruitment agent. As well as the email subject, attachments and the email body could also be checked.

In this example, emails from AccRec are standardised and have the subject “Accountancy role candidate [name]”, and so the emails from them that relate to recruitment contain the keyword flag “candidate” in the email header. On receipt of such an email, the controller 304 controls the email client 114 to forward the received email to an employee in the human resources function, such as the HR manager. Furthermore, the controller 304 then sends a control signal to the email client 114 installed on the senior accountant's PC instructing it to delete the received email. This prevents the senior accountant acting on the email and consequently he can not inadvertently implement AccRec's terms and conditions against the will of the HR department.

As explained, this process is advantageous to Y&E as they do not wish for non-HR employees to take any role in the recruitment process. It enables the HR department to be fully in control of recruitment as they will know precisely how to respond to recruitment-related emails. Unexpected costs can not be incurred by an employee unwittingly ratifying a recruitment agent's terms and conditions when these terms and conditions are not in line with Y&E's.

As a further example, consider a situation in which a partner at an accountancy firm is approached by a recruiter representing an individual that is interested in exploring other opportunities. The individual represented is also a partner with a track record of generating a £1,000,000 of fees per annum for the last four years. He is interested in moving because the firm he currently represents is not growing organically and is limited in certain areas that would help his client base. The accountancy firm the recruiter has approached is interested in meeting this individual as his area of expertise would complement the firm and he has a solid client base with impressive billings. The partner approached requests his CV and based on the CV asks for an interview. The partner arranging the interview does not check with HR or the Managing Partner what the Firm's recruitment policy is and arranges the interview, thus engaging in a contract.

If a system according to the invention had been installed as soon as the CV had been received the automated response would have triggered. This would have stipulated that any engagement/interview was on the accountancy firm's terms and that a maximum recruitment fee of £125,000 is the ceiling for what the firm would be prepared to pay. It would have insisted that this was agreed to via electronic confirmation before the interview and thus terms and conditions are in force. It would also have made the Head of HR and/or the Managing Partner aware that an approach had been made.

If the accountancy firm in question hire this individual without enforcing their own terms the typical market rate is 25% of first year billings thus £250,000. Moreover they would be on notice of terms and conditions via the recruiter's CV, with small print of this is subject to our terms and conditions. As such this example illustrates how substantial savings could be made at the point of engagement. In addition, it should be noted that typically these introductions are made by contingent recruiters and any indication of interest could earn them a substantial fee. The likelihood is they will agree to the client's terms and conditions because the chances of several firms looking to hire in a specific area at partner level are low.

FIG. 8 shows a flowchart for the operation of the email client plugin module 202 according to another embodiment of the present invention. Steps 402, 404, and 406, can be carried out in any of the ways described above.

After the parsing step 404, the plugin module 202 executes step 502. In step 502 the controller 304 controls the display 310 to display a message to the user in any suitable form. For example, the message may be a popup window in the form of a warning message. For example, the message may remind the user of their company's policies relating to how to deal with an email relating to recruitment.

In other embodiments, the message may not be a pop up window. Instead, the user is informed, or reminded, to treat the recruitment-related email differently by the email client 114 displaying the email differently in the inbox 814. For example, the email descriptor in the inbox may be written in a different font to the other emails. Alternatively, the email descriptor may be written in a different colour. Alternatively, the icon representing the email may be changed to an icon not typically associated with emails.

This process is advantageous for small firms where each employee is required to have a large responsibility and there is no HR department. Furthermore, employees in small firms may prefer to have more of a sense of control over the firm and to carry out actions, such as responding to emails, in their own style. Furthermore, a small company is less likely to have a standard set of recruitment terms and conditions.

To that end the fact the email is not automatically replied to in, as in the embodiment described in relation to FIG. 5, may give employees more choice over their responses.

For example, a small online sales company Bosawas, having a managing director and three employees, has no HR department to deal with such issues as recruitment terms and conditions. Indeed, Bosawas does not have a standard set of terms and conditions. However, there is still a need to prevent Bosawas unwittingly entering into contracts with recruitment agents that are based on undesirable terms and conditions.

Therefore, a Bosawas employee receiving a recruitment-related email would be expected to be mindful of the dangers associated with responding to it without first informing the recruitment agent of Bosawas'-s terms and conditions

The head of sales at Bosawas wishes to hire a new sales person. The head of sales contacts a number of recruitment agents and tells them to send emails relating to any potential candidates to his email address.

Bosawas installs the plugin module 202 and installs it in their internal network server 108. In this configuration, emails are parsed before they are received by the email client 114 installed on employee PCs no.

In this example, the head of sales makes a record of all the recruitment agents he contacted and enters their domain names into the flag information store 306. Therefore, the domain of the recruitment agent sending any recruitment-related email is known to the plugin module 202.

Furthermore, the parser 312 is configured to identify certain recruitment related keywords in the body of the email.

In this example, the email is sent from a known recruitment agent, and the email comprises a message in its body explaining a candidate's hobbies and education. Therefore it is determined by the plugin module 202 that the received email is related to recruitment. In addition, the system is still filtering all of the data so that any introduction from a recruiter that the Managing Director has not contacted is also filtered and the automated response of terms and conditions is sent.

As a result of a positive outcome to the parsing, a warning message is displayed to the head of sales via his display 310. The warning message informs the employee about the dangers of responding to the email without first discussing details such as rates and renumeration with the recruitment agent. This allows the head of sales to craft a personalised response to the recruitment agent 118 in a way that they think best represents the business.

FIG. 9 shows an example of a user interface 204 according to an embodiment of the invention.

The user interface 204 is designed to be easy to use. Each user interface element corresponds to a particular filter configuration setting in the XML file stored in memory 206. The user interface elements may comprise at least one of Boolean, enumeration and text 806, check boxes 802, combination boxes and text boxes 804 to configure and control the settings.

The user interface 204 assists the user in managing the plugin module 202. More specifically, the user interface allows a user to define new filters 808, modify existing filters 808 and remove filters 808.

Filters 808 may be “AND” filters or “OR” filters, or a combination of the two. For example, to be identified as related to recruitment, the email must contain all of the filter terms, or one of the filter terms.

For each filter 808, a specific action to be carried out is decided by the user—If the client wishes for the system to be configured in a specific way. Arguably the Client will request that the employees does not have to fulfil an action. Moreover HR will be made aware of introductions by the automated forwarding and will follow up with the recruiter for electronic acceptance of the Company's terms and conditions relating to recruitment introductions.

For example, if a keyword is identified in an email then the email is forwarded to HR according to “Filter_{—}1” 808 shown in FIG. 8. In another example of a filter, if an email is received from a particular sender, it may be automatically responded to—this is pertinent and dealt with effectively by the white list for internal emails and by adding certain email addresses for known recruiters that make approached.

As discussed, embodiments of the invention provide a method of handling electronic mail containing information related to recruitment that comprises storing at least one item of flag information related to recruitment of personnel and receiving, at a first email address, a first email from a sender having a second email address. Information related to the first email is then compared with at least one item of stored flag information and determining whether the information related to the first email contains at least one item of flag information. An action can then the executed an action as a result of a positive determination.

Embodiments of the invention can also provide apparatus comprising: a memory arranged to store at least one item of flag information related to recruitment of personnel; an email client arranged to receive a first email from a second email address; a processor arranged to compare information related to the first email with the items of stored flag information and to determine the information related to the first email contains at least one item of flag information; and a controller arranged to execute an action as a result of a positive determination.

It will, of course, be appreciated that embodiments of the invention are not limited to a particular email client or email system. There are a large variety of email client/server arrangements, and the invention can be embodied on these in a suitable way. The email client of embodiments of the invention can be stored on a local device accessed by a user, or stored on a network device and accessed by the user via the network. Likewise, the memory arranged to store at least one item of flag information related to recruitment of personnel may be located on a local device of a user, or on a remote device, for example a device accessible by a network. Similarly, the processor arranged to compare information related to the first email with the items of stored flag information and to determine the information related to the first email contains at least one item of flag information and the controller arranged executing an action as a result of a positive determination could be either local or remote devices. In embodiments in which one or more elements of the apparatus are remote devices, there is no requirement for these remote devices to be located on the same remote device.

It will be appreciated that the hardware used by embodiments of the invention can take a number of different forms. For example, all the components of an apparatus of an embodiment of the invention could be provided by a single device (e.g. the example of FIG. 3), or different components of the apparatus could be provided on separate devices. More generally, it will be appreciated that embodiments of the invention can provide a system that comprises one device or several devices in communication.

It will be understood from the foregoing description that various modifications and changes may be made in the preferred embodiment of the present invention without departing from the true spirit, such as alternative electronic mail systems, operating systems, and code language. It is intended that this description is for purposes of illustration only and should not be construed in a limiting sense. The scope of this invention should be limited only by the language of the following claims.

1. A method of handling electronic mail containing information related to recruitment, the method comprising:
storing at least one item of flag information related to recruitment of personnel;
receiving, at a first email address, a first email from a sender having a second email address;
comparing information related to the first email with at least one item of stored flag information and determining whether the information related to the first email contains at least one item of flag information; and
executing an action as a result of a positive determination.

2. The method of claim 1, wherein the executed action is the sending of a second email to a third email address.

3. The method of claim 2, wherein the third email address is the same as second email address.

4. The method of claim 3, wherein the second email contains recruitment terms and conditions of the organisation to which the first email address belongs.

5. The method of claim 2, wherein the third email address is an internal email address, and belongs to a user in the human resources function.

6. The method of claim 5, wherein the second email is a copy of the first email.

7. The method of claim 1, wherein the executed action is the providing of an alert to a user of the first email address.

8. The method of claim 1, further comprising comparing content of at least one of an email header, an email body, or an email attachment of the first email with the items of stored flag information.

9. The method of claim 1, wherein the at least one item of flag information comprises an email address of a recruiter.

10. The method of claim 1, wherein the at least one item of flag information comprises one or more keywords relating to recruitment.

11. The method of claim 1, further comprising storing flag setting information related to the at least one item of flag information.

12. The method of claim 11, wherein the flag setting information includes information on which portion of the first email an item of flag information needs to be present in for a positive determination to be made.

13. The method of claim 11, further comprising storing a plurality of items of flag information related to recruitment of personnel, wherein the flag setting information defines that two or more items of flag information need to be found in combination for a positive determination to be made.

14. The method of claim 1, further comprising receiving configuration information from an XML file stored in an external memory.

15. The method of claim 1, wherein the method further comprises determining whether the second email address is an internal email address, and if the second email address is an internal email address not executing the action following the positive determination.

16. The method of claim 1, wherein the method further comprises determining whether the second email address is contained in a white list of email addresses, and if the second email address is contained in the white list not executing the action following the positive determination.

17. The method of claim 1, wherein the method further comprises determining whether the first email is part of a same email chain as a previous email received from the second email address, and if the first email is part of the a same email chain as the previous email received from the second email address not executing the action following the positive determination.

18. A computer program product comprising computer readable instructions for carrying out the method of claim 1.

19. An apparatus comprising:
a memory arranged to store at least one item of flag information related to recruitment of personnel;
an email client arranged to receive a first email from a second email address;
a processor arranged to compare information related to the first email with the items of stored flag information and to determine the information related to the first email contains at least one item of flag information; and
a controller arranged to execute an action as a result of a positive determination.

20. The apparatus of claim 19, wherein the executed action is the sending of a second email to a third email address.

21. The apparatus of claim 20, wherein the third email address is the same as second email address.

22. The apparatus of claim 19, wherein the second email contains recruitment terms and conditions of the organisation to which the first email address belongs.

23. The apparatus of claim 17, wherein the third email address is an internal email address, and belongs to a user in the human resources function.

24. The apparatus of claim 23, wherein the second email is a copy of the first email.

25. The apparatus of claim 19, wherein the executed action is the providing of an alert to a user of the first email address.

26. The apparatus of claim 19, wherein the processor is arranged to compare at least one of an email header, an email body, or an email attachment of the first email with the items of stored flag information.

27. The apparatus of claim 19, wherein the at least one item of flag information comprises an email address of a recruiter.

28. The apparatus of claim 19, wherein the at least one item of flag information comprises one or more keywords relating to recruitment.

29. The apparatus of claim 19, further comprising an external memory for storing configuration information in an XML file.

30. The apparatus of claim 19, wherein the processor and controller are embedded in the email client.

31. The apparatus of claim 19, wherein the processor is further configured to determine whether the second email address is an internal email address, and if the second email address is an internal email address the controller is configured to not execute the action following the positive determination.

31. The apparatus of claim 19, wherein the processor is further configured to determine whether the second email address is contained in a white list of email addresses, and if the second email address is contained in the white list the controller is configured to not execute the action following the positive determination.

32. The apparatus of claim 19, wherein the processor is further configured to determine whether the first email comprises a same email header as a previous email received from the second email address, and if the first email comprises the same email header as the previous email received from the second email address the controller is configured to not execute the action following the positive determination.
